(19) United States
(12) Patent Application Publication
(10) Pub. No.: US 2024/0262163 A1
(43) Pub. Date: Aug. 8, 2024

(54) THERMAL MANAGEMENT MODULE

(71) Applicant: MAHLE INTERNATIONAL GMBH, Stuttgart (DE)

(72) Inventors: Dominik BEHNERT, Stuttgart (DE); Hannes STADLER, Stuttgart (DE)

(21) Appl. No.: 18/428,368

(22) Filed: Jan. 31, 2024

(30) Foreign Application Priority Data
Feb. 6, 2023 (DE) 102023200935.8

(51) Int. Cl. B60H 1/00

(52) U.S. Cl. CPC B60H 1/00899; B60H 1/00385; B60H 1/00278; B60H 2001/00942

(57) ABSTRACT

A thermal management module is provided. The module includes
a first heat exchanger,
a second heat exchanger,
a first flange located between the first heat exchanger and second heat exchanger, in which there are fluid channels connecting the first heat exchanger to the second heat exchanger for fluid exchange, and a first receiver for a first valve assembly,
a second flange on the first heat exchanger or second heat exchanger, which has a second receiver for a second valve assembly. This results in a compact structure and a means of supplying fluid to the first heat exchanger and second heat exchanger from different directions.

### CROSS-REFERENCE TO RELATED APPLICATIONS

This application claims priority from German Patent Application No. DE102023200935.8, filed Feb. 6, 2023, the entirety of which is hereby fully incorporated by reference herein.

The present invention relates to a thermal management module. The invention also relates to a motor vehicle, in particular an electric vehicle, which has such a thermal management module.

Thermal management modules are used in modern temperature control units such as air conditioning systems and cooling units, in particular in electric vehicles, to control the temperature of a vehicle interior or a vehicle battery. To be able to control this, it must be possible to control a coolant flow or refrigerant flow, for which valve assemblies are usually used.

These valve assemblies are placed on a flange between two heat exchangers that are connected together for fluid exchange. The problem with this is that the flange between the heat exchangers must be wide enough to accommodate the valve assemblies. In particular, it must accommodate the channels between the valve assemblies within the flange. The amount of space available for the flange is limited, however.

The present invention therefore addresses the problem of creating a better, or at least alternative, design for a thermal management module with which these disadvantages can be eliminated.

This problem is solved according to the invention by the subject matter of independent claim 1. Advantageous embodiments are the subject matter of the dependent claims.

The present invention is based on the general idea of providing a second flange on either the first or second heat exchanger, in addition to the flange between the two adjacent heat exchangers, such that at least one valve assembly can be placed on both the first flange and the second flange. As a result, the first flange does not have to be too wide between the two heat exchangers. The thermal management module according to the invention has a first heat exchanger and a second heat exchanger, as well as the aforementioned first flange between the two heat exchangers, which can be in the form of a flange plate and in which there are fluid channels that connect the first heat exchanger to the second heat exchanger, and at least a first receiver for a first valve assembly. There is also a second flange on either the first or second heat exchanger, which has a second receiver for the second valve assembly. If the first heat exchanger is an internal heat exchanger (IHE) and the second heat exchanger is a chiller, when the second flange is on the first heat exchanger, the first heat exchanger can be supplied with fluid at opposing intakes by the second heat exchanger (chiller) and through the second valve assembly by an evaporator. The second valve assembly can be or contain a unidirectional valve. On the whole, fluid can be supplied to the first heat exchanger from the second heat exchanger or an evaporator with this thermal management module. Moreover, the components can be more easily placed in the installation space, and more easily connected to A/C lines. The fluid lines for different refrigerants, e.g. from the chiller and evaporator, can be separated, making it easier to place the p/T sensors in the system.

In an advantageous embodiment of the thermal management module, the first valve assembly is or contains an expansion valve. This expansion valve reduces the pressure in the fluid, e.g. a refrigerant, by restricting the flow cross section, thus allowing an increase in volume, or an expansion. Expansion valve assemblies are used in air conditioners, for example.

In another advantageous embodiment of the thermal management module according to the invention, the second valve assembly is or contains a unidirectional valve. This type of unidirectional valve can be placed between the first heat exchanger and the evaporator, thus on the second flange, such that a refrigerant can flow at a regulated pressure from the evaporator to the first heat exchanger through the unidirectional valve. It cannot flow in the other direction. This also separates the fluid lines for the various refrigerants, e.g. in the chiller and evaporator, such that the p/T sensors can be more easily placed in the system.

The first flange has at least two openings into the first heat exchanger and at least two openings into the second heat exchanger through which fluid can flow. This makes it possible to supply and remove refrigerant through the first flange to and from the first heat exchanger as well as to and from the second heat exchanger.

In another advantageous embodiment of the thermal management module according to the invention, the first heat exchanger, first flange, second heat exchanger, and second flange are soldered together. This results in a module that can be preassembled, in which the individual elements can be connected to one another with a reliable seal between them. Purely theoretically, it is also possible to clamp seals between the individual components.

In a particularly preferred embodiment, the first flange and/or second flange are made of aluminum. These can be milled or cast aluminum parts. Aluminum has the advantages of high heat conductivity and low weight. This is of particular interest for use in electric vehicles.

In another advantageous embodiment of the thermal management module according to the invention, the first valve assembly is screwed, clamped or soldered to the first flange. It should be clear that there are numerous means of attachment, including both releasable connections, such as screws, and non-releasable connections, such as those obtained with soldering. The second valve assembly can also be screwed, clamped or soldered to the second flange.

The present invention is also based on the general idea of equipping a motor vehicle, in particular an electric vehicle, with the thermal management module described above, and thus obtaining the advantages of the thermal management module for the vehicle, in particular the electric vehicle. In concrete terms, the amount of necessary installation space is reduced by the design of the thermal management module, and it is possible to supply fluid to the first heat exchanger from the other side, which would not be possible if the second valve assembly were also located in the first flange.

Other important features and advantages of the invention can be derived from the dependent claims, the drawings, and the description in reference to the drawings.

It should be clear that the features specified above and described below can be used not only in the combinations given therein, but also in other combinations or in and of themselves, without abandoning the scope of the present invention. Components of a higher level unit specified above and in the following, e.g. a device, apparatus or assembly, that are indicated separately, can form separate parts or components of this unit or be integral parts or sections thereof, even if they are not shown as such in the drawings.

Preferred exemplary embodiments of the invention are shown in the drawings and shall be explained in greater detail below, in which the same reference symbols are used for the same, similar, or functionally similar components.

Therein, schematically:

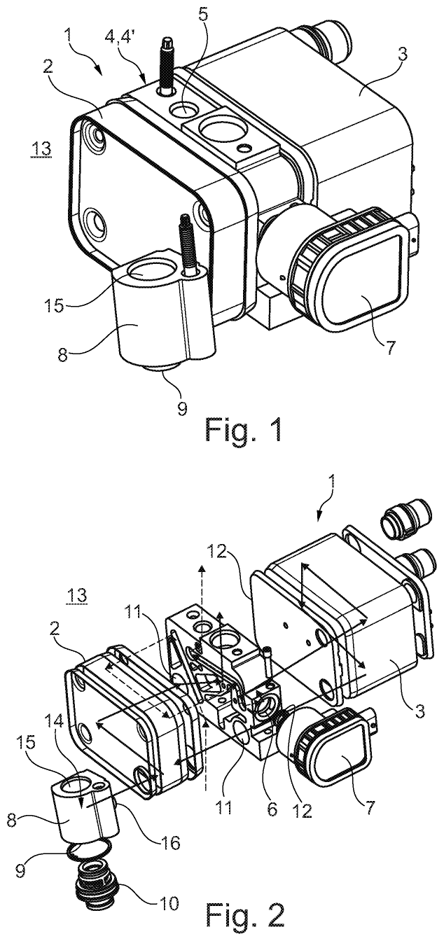

FIG. 1: a first thermal management module according to the invention, with a first valve assembly on a first flange; and

FIG. 2: the same illustration as in FIG. 1, but in an exploded view and with a second valve assembly on a second flange.

As shown in FIGS. 1 and 2, a thermal management module 1 according to the invention contains a first heat exchanger 2 and a second heat exchanger 3. The first heat exchanger 2 can be an internal heat exchanger (IHE), while the second heat exchanger 3 can be a chiller. There is a first flange 4, in particular in the form of a flange plate 4′, between the first heat exchanger 2 and second heat exchanger 3, in which there are fluid channels 5 connecting the first heat exchanger 2 to the second heat exchanger 3, and a first receiver 6 for a first valve assembly 7. The first valve assembly 7 can be an expansion valve, for example.

There is a second flange 8 on the first heat exchanger 2 or second heat exchanger 3, in this case the first heat exchanger 2, which has a second receiver 9 for a second valve assembly 10. The second valve assembly 10 can be a unidirectional valve, for example.

The first flange 4 has at least two openings 11 through which fluid can flow to or from the first heat exchanger 2, and at least two openings 12 through which fluid can flow to or from the second heat exchanger 3. Fluid, e.g. a refrigerant, can therefore be supplied to and removed from first heat exchanger 2 and second heat exchanger 3.

The first heat exchanger 2, first flange 4, second heat exchanger 3, and second flange 8 can be soldered to one another, resulting in not only a compact module, but also a module that can be easily assembled, with a reliable sealing. Instead of soldering, the individual components 9, 2, 4 and 3 can also be screwed together. The second flange 8 can also be soldered to the first heat exchanger 2 and the second heat exchanger 2 can be screwed to the first flange 4 and the second heat exchanger 3.

The first flange 4 and/or second flange 8 can be made of aluminum, e.g. as milled or cast aluminum parts. Aluminum exhibits a high heat conductivity and low weight. Moreover, it is easy to solder aluminum, thus simplifying production of the thermal management module according to the invention.

The second flange 8 has a T-shaped channel, in which an entry 15 to the evaporator 14 is opposite the second receiver 9. An outlet 16 is connected to the first heat exchanger 2 in FIG. 2.

The first valve assembly 7, e.g. an expansion valve, can be screwed, clamped, or soldered to the first flange 4, in particular the first flange plate 4′. Purely theoretically, a bayonet connection can also be used. The second valve assembly 10 can also be screwed, clamped, or soldered to the second flange 8.

FIG. 2 contains flow arrows, the solid arrows indicating a refrigerant flow at the intake end, and the broken arrows indicating a refrigerant flow to the fluid end.

The thermal management module 1 can be use in a motor vehicle 13, in particular an electric vehicle, for controlling the temperature of a vehicle interior or a vehicle battery. The first heat exchanger 2 and/or second heat exchanger 3 can be conventional stacked plate heat exchangers.

On the whole, the thermal management module 1 is optimized with regard to installation space, which also allows for a compact attachment of the second valve assembly 10. Furthermore, fluid can be conveyed independently to the first heat exchanger 2 from the second heat exchanger 3 or an evaporator 14.

The specification is readily understood with reference to the following Numbered Paragraphs:

Numbered Paragraph 1. A thermal management module (1), comprising
a first heat exchanger (2),
a second heat exchanger (3),
a first flange (4) located between the first heat exchanger (2) and second heat exchanger (3), in which there are fluid channels (5) connecting the first heat exchanger (2) to the second heat exchanger (3) for fluid exchange, and a first receiver (6) for a first valve assembly (7),
a second flange (8) on the first heat exchanger (2) or second heat exchanger (3), which has a second receiver (9) for a second valve assembly (10).

Numbered Paragraph 2. The thermal management module according to Numbered Paragraph 1, characterized in that the first valve assembly (7) contains an expansion valve.

Numbered Paragraph 3. The thermal management module according to Numbered Paragraph 1 or 2, characterized in that the second valve assembly (10) contains a unidirectional valve.

Numbered Paragraph 4. The thermal management module according to any of the preceding Numbered Paragraphs, characterized in that the first flange (4) has at least two openings (11) into the first heat exchanger (2) and at least two openings (12) into the second heat exchanger (3) through which fluid can pass.

Numbered Paragraph 5. The thermal management module according to any of the preceding Numbered Paragraphs, characterized in that the first heat exchanger (2), first flange (4), second heat exchanger (3), and second flange (8) are soldered or clamped together.

Numbered Paragraph 6. The thermal management module according to any of the preceding Numbered Paragraphs, characterized in that the first flange (4) and/or second flange (8) are made of aluminum.

Numbered Paragraph 7. The thermal management module according to any of the preceding Numbered Paragraphs, characterized in that the first valve assembly (7) is screwed, clamped, or soldered to the first flange (4).

Numbered Paragraph 8. The thermal management module according to any of the preceding Numbered Paragraphs, characterized in that the second valve assembly (10) is screwed, clamped, or soldered to the second flange (8).

Numbered Paragraph 9. A motor vehicle (13) that has a thermal management system (1) according to any of the Numbered Paragraphs 1 to 8.

Numbered Paragraph 10. The motor vehicle according to Numbered Paragraph 9, characterized in that the motor vehicle (13) is an electric vehicle.

1. A thermal management module, comprising
a first heat exchanger,
a second heat exchanger,
a first flange located between the first heat exchanger and second heat exchanger, in which there are fluid channels connecting the first heat exchanger to the second heat exchanger for fluid exchange, and a first receiver for a first valve assembly,
a second flange on the first heat exchanger or second heat exchanger, which has a second receiver for a second valve assembly.

2. The thermal management module according to claim 1, wherein the first valve assembly comprises an expansion valve.

3. The thermal management module according to claim 1, wherein the second valve assembly further comprises a unidirectional valve.

4. The thermal management module according to claim 1, wherein the first flange has at least two openings into the first heat exchanger and at least two openings into the second heat exchanger through which fluid can pass.

5. The thermal management module according to claim 1, wherein the first heat exchanger, first flange, second heat exchanger, and second flange are soldered or clamped together.

6. The thermal management module according to claim 1, wherein the first flange and/or second flange are made of aluminum.

7. The thermal management module according to claim 1, wherein the first valve assembly is screwed, clamped, or soldered to the first flange (4).

8. The thermal management module according to claim 1, wherein the second valve assembly is screwed, clamped, or soldered to the second flange.

9. A motor vehicle that has a thermal management system according to claim 1.

10. The motor vehicle according to claim 9, wherein the motor vehicle is an electric vehicle.
